(19) United States
(12) Patent Application Publication
(10) Pub. No.: US 2012/0150899 A1
(43) Pub. Date: Jun. 14, 2012

(54) SYSTEM AND METHOD FOR SELECTIVELY GENERATING TABULAR DATA FROM SEMI-STRUCTURED CONTENT

(76) Inventors: Steve Minton, El Segundo, CA (US); Brian Amanatullah, Manhattan Beach, CA (US); Matthew Michelson, Playa del Rey, CA (US)

(21) Appl. No.: 12/965,756

(22) Filed: Dec. 10, 2010

(51) Int. Cl. G06F 17/30

(52) U.S. Cl. 707/769; 707/E17.014

(57) ABSTRACT

Disclosed is a computer implemented method for acquiring specified web-based data in a tabular format, the method comprising the steps of: performing a web searching operation to acquire web pages containing predefined data; and placing the predefined data into columns of a structural table to form a modifiable table, the characteristics and positions of the modifiable table columns being subsequently determined by a user.

### BACKGROUND

1. Technical Field

The present invention generally relates to network data extraction and data tabulation and, in particular, to a process for generating data tables from web content pages in real time.

2. Background

The Internet remains a valuable source of information for various needs. A large volume of data is accessible to the user who wishes to conduct research, query multiple databases and websites, and download data of interest. Such data is most usefully aggregated for presentation in summarized tabular form. Although this can be done manually by the user by opening and populating a spreadsheet, for example, such an approach may become very tedious if the amount of data is large. What is needed is a method for automatically converting downloaded data into tabular form by a process which remains under control of the user.

### SUMMARY OF THE PRESENTLY CLAIMED INVENTION

In one aspect of the present invention, a computer implemented method for acquiring specified web-based data in a tabular format, the method comprising the steps of: performing a web searching operation to acquire web pages containing predefined data; and placing the predefined data into columns of a structural table to form a modifiable table, the characteristics and positions of the modifiable table columns being subsequently determined by a user.

In another aspect of the present invention, a computer readable storage medium having embodied thereon a program, the program being executable by a processor to perform a method for acquiring specified web-based data in a tabular format, the method comprising: performing a web searching operation to acquire web pages having predefined data; and placing the predefined data into columns of a modifiable table, the characteristics and positions of the table columns being determined by a user.

In still another aspect of the present invention, a device suitable for acquiring specified web-based data and converting to a modifiable table, the device comprising: means for acquiring web-based data; a memory for storing a tabulation application that, when executed, functions to convert the acquired web-based data into a modifiable table; and a display for displaying at least one of the web-based data and the modifiable table to a user.

### BRIEF DESCRIPTION OF THE DRAWINGS

FIG. 1 illustrates an exemplary computer system having a processing unit and a display unit for generating data tables from web content pages in real time, in accordance with the present invention;

FIG. 2 is a flow diagram illustrating an exemplary method of table generation performed by a tabulation application executed in the computer system of FIG. 1;

FIG. 3 is a generalized flow diagram 300 illustrating an exemplary method of table generation.

FIG. 4 is a diagrammatical illustration of web pages selected for data extraction by a user of the computer system of FIG. 1;

FIG. 5 illustrates a structural table for entry of data from the web pages shown in FIG. 4;

FIG. 6 shows a listing table provided in the display unit of the computer system of FIG. 1 for the entry of selected URLs;

FIG. 7 is a screen shot of a web page and associated URL as viewed by a user of the computer system of FIG. 1;

FIG. 8 is a screen shot illustrating the operation of sending a user selected group of URLs for processing by the tabulation application in the computer system of FIG. 1;

FIG. 9 is a screen shot illustrating a structural table generated in response to the action performed in FIG. 8;

FIG. 10 is a screen shot showing that a user is viewing a selected web page 1010 containing a particular subject matter of interest;

FIG. 11 is a screen shot illustrating the selection of a merge operation via a drop down menu provided in the structural table of FIG. 9;

FIGS. 12A and 12B are screen shots illustrating the execution of table generation operation of FIG. 3;

FIG. 13 is a flow diagram illustrating a process for generating data tables;

FIG. 14 is a screen shot of the user-modified table of FIG. 9 after selected columns have been saved in the structural table, in accordance with the user selections of FIGS. 13A and 13B;

FIG. 15 is a screen shot showing the user-modified table of FIG. 14 with user-selected column headings;

FIGS. 16A and 16B are screen shots showing a user saving a format of a table;

FIGS. 17-19 are screen shots which may be provided by the present technology.

FIG. 20 illustrates an exemplary embodiment of a computing system.

### DETAILED DESCRIPTION OF THE INVENTION

The disclosed invention provides a device and method for generating data tables from web content pages in real time, where either a user can cluster selected web pages, or the device can assemble the cluster. Once the data are in a cluster, the user or the device can convert the data into tabular data. The format of the generated table is a function of the type of data retrieved from the web pages. For example, changes made to the cluster automatically change the corresponding table. If new data indicates a new, different column in the table, the additional column is automatically incorporated into the table. The disclosed device and method function to find similarity among the web pages, and produces a user-modifiable table based on such similar attributes.

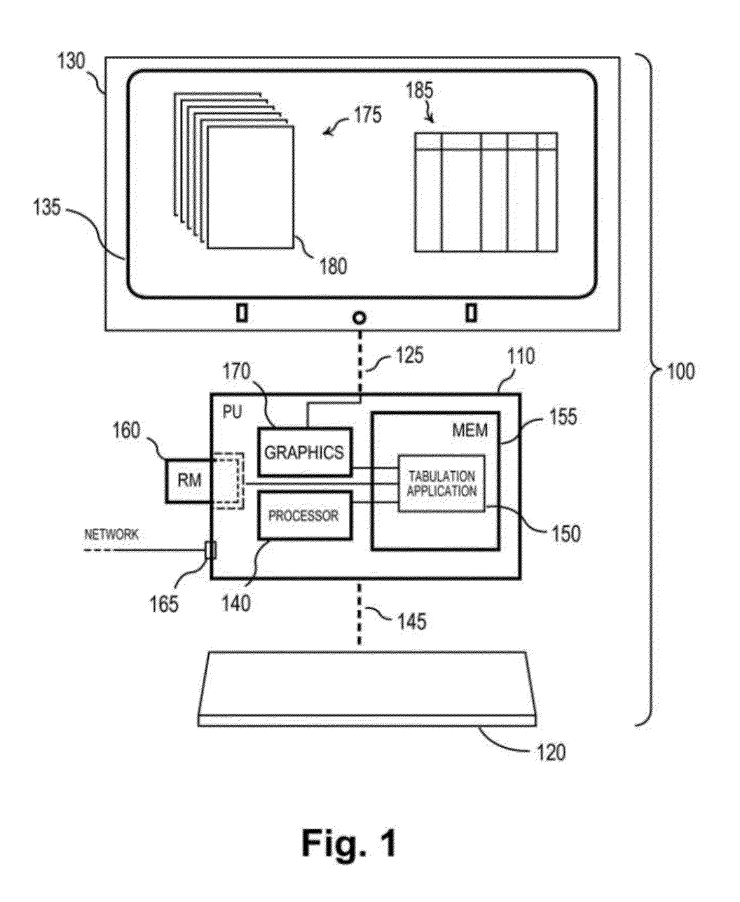

There is shown in FIG. 1 a diagrammatical illustration of an exemplary embodiment of a computer system 100 suitable for use in downloading web page data and formatting into a modifiable table, in accordance with methods described in greater detail below. In the embodiment shown, the computer 100 comprises a processing unit 110, an input keyboard 120, and a display unit 130, such as an LCD screen or a plasma screen. The processing unit 110 communicates with the display unit 130 via a display link 125, that may be wired or wireless. The display unit 130 functions to provide a display 135 to a user, as well known in the relevant art. The input keyboard 120 communicates with the processing unit 110 via an input link 145, that may be wired or wireless. In an alternative embodiment, the computer 100 may comprise a laptop device, a mobile phone, a notebook computer, a personal digital assistant, or any other mobile device capable of communicating over a network.

The processing unit 110 may include a processor 140 operating to execute a tabulation application 150 resident in a memory 155. The tabulation application 150 may be implemented as a program, software, code, or other instructions stored in the memory 155. Alternatively, the memory 155 and the tabulation application 150 may be provided as a single component, as a firmware chip (not shown), for example. A removable memory 160 and a network port 165 may be provided in the computer 100 for inputting data and software. The network port 165 may provide for an Ethernet connection as shown, for example, or may be a wireless port (not shown). The network port 165 may thus be used to communicate with any communication network such as the Internet, a Wide Area Network (WAN), a Local Area Network (LAN), an intranet, an extranet, a private network, a public network, one or more mobile device networks, a combination of these networks, or other communication network.

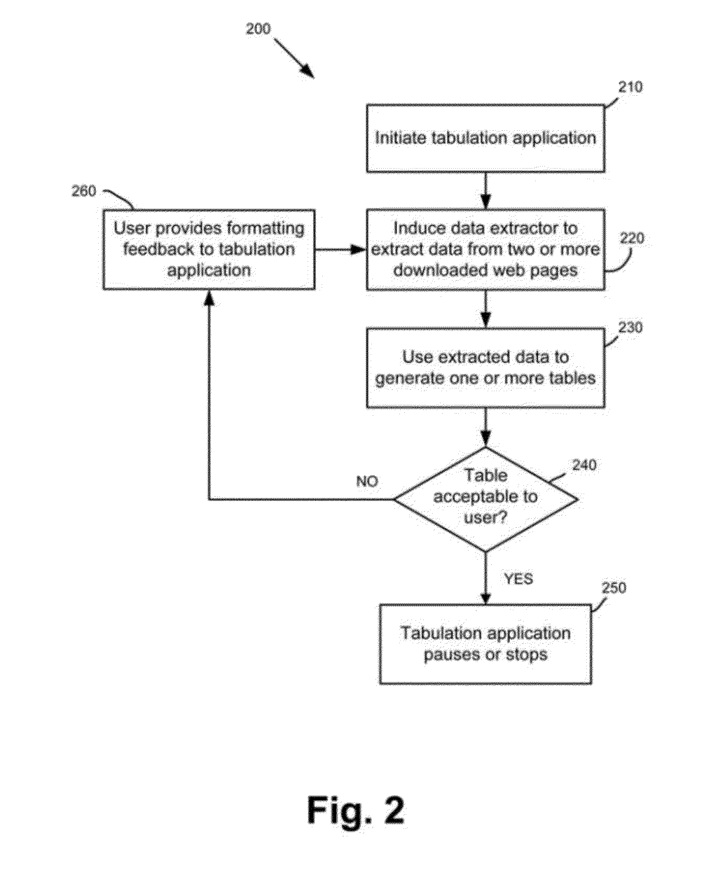

The tabulation application 150 functions to convert data extracted from a plurality of web pages into tabular form, in accordance with an aspect of the present invention. That is, the tabulation application 150 makes “suggestions,” and the human user assists in the table modification process. As shown in a generalized flow diagram 200 in FIG. 2, the tabulation application 150 is initiated, at step 210, and a data extractor is induced to extract data from two or more downloaded web pages 180, at step 220. The data extractor functions in response to the acquisition of a set of sample pages corresponding to a specified page type, where the specified page type includes common features found in a set of similarly-formatted web pages. The tabulation application 150 induces the extractor to extract data fields from these similarly-formatted web pages.

For example, if the user has accessed a website offering books for sale, the tabulation application 150 may induce an extractor that extracts from a specified book web page: the title of the specified book, the price for the specified book, whether the book is hardcover or softcover, the number of pages in the book, and the ISBN for the book.

The extracted data is used by the tabulation application 150 to generate one or more tables 185, at step 230. The tables include all the data fields extracted from the similarly-formatted web pages. A graphics module 170 enables the user to view in the user display 135 a downloaded cluster 175 of these web pages 180 and the one or more tables 185 generated from the data extracted from the web pages 180, as described in greater detail below. If the one or more generated tables 185 are acceptable to the user, at decision block 240, the tabulation application 150 may pause or stop, at step 250.

However, if any of the one or more generated tables 185 are not acceptable to the user, at decision block 240, the user provides formatting feedback to the tabulation application 150, at step 260, and the process returns to step 220. For example, the extractor may have extracted pricing data for a plurality of book web pages, in the example provided above, and created two separate cost fields, one cost field comprising dollar amounts and the other cost field comprising cents.

This table may not be acceptable to the user who prefers a single cost field including both dollars and cents, including a decimal point. Accordingly, the user collaborates with the tabulation application 150 by giving feedback in the form of modifications to the one or more tables. As described in greater detail below, the tabulation application 150 responds by re-learning the extractor such that the extractor subsequently operates to regenerate the one or more tables in accordance with the preferences of the user. This feedback process may include one or more cycles of providing formatting feedback and re-learning the extractor with the tabulation application 150.

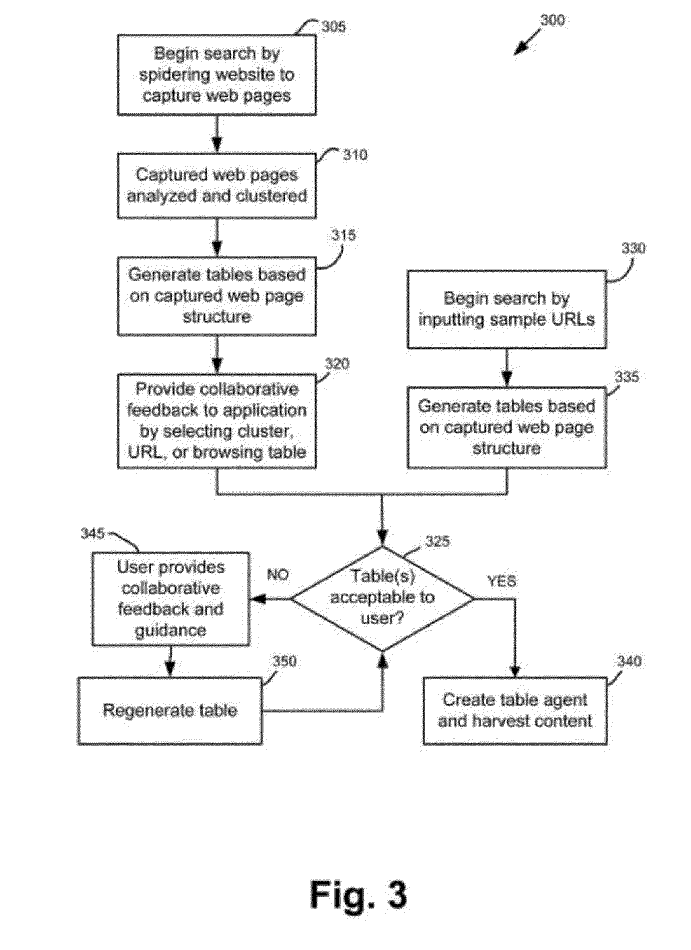

FIG. 3 is a generalized flow diagram 300 illustrating an exemplary method of table generation. The tabulation application 150 functions to first capture the web pages 180 by either spidering a user-specified site or by downloading web pages in accordance with a user-provided URL. A site extraction process may be initiated, for example, by accessing the Internet to perform a web crawling operation and spidering various websites to capture the web pages 180, at step 305. It should be understood that there are no particular criteria for the searching and is performed in accordance with the user references. The user may begin searching unsyndicated content, where the structure of a web page need not be explicit, but may be semi-structured, and where the web page may have some underlying grammar.

Relevant web pages 180 are retrieved, analyzed for page content, and aggregated into one or more clusters 175 of web pages 180, at step 310, preferably so that segments from similar relational columns are grouped together. The clustering operation is typically performed by grouping similar web pages 180 together for presentation to the user. In an exemplary embodiment, the web page capture, data extraction, and text-segment clustering can be performed as described in commonly-assigned patent application publication US 2008/0114800 “Method and system for automatically extracting data from websites,” incorporated in entirety herein by reference.

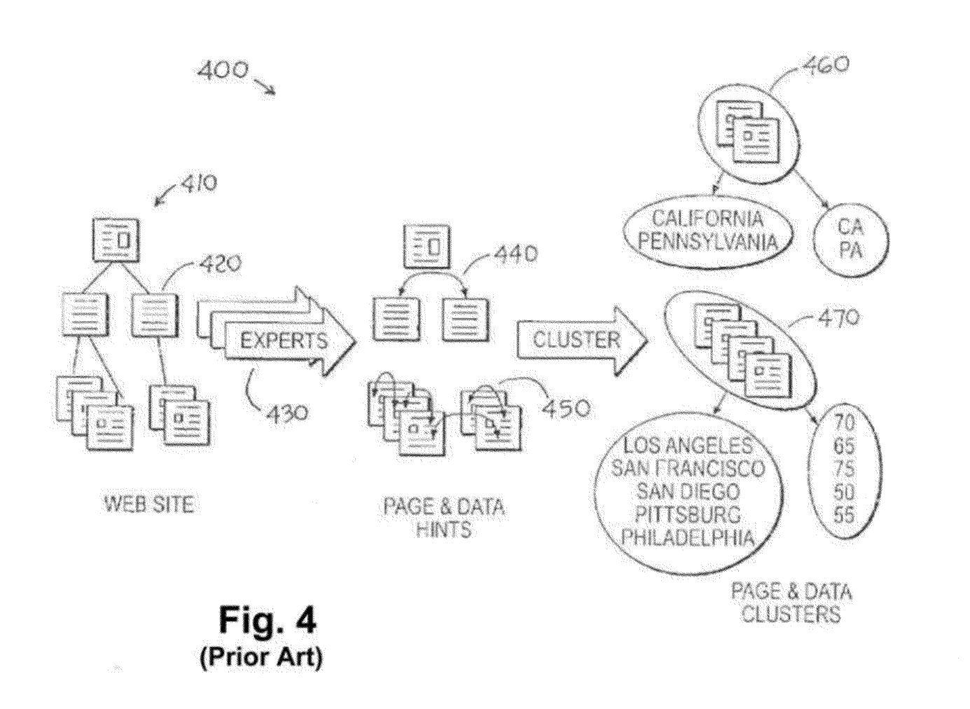

Generally, site extraction at step 305 can be performed by discovering low-level structure; clustering pages and text segments to find a consistent global structure; and finding the relational form of the data from page and text-segment clusters. The discovery process may begin by first spidering a set of HTML web pages 420 in a web site 410 having data for extraction, such as the web pages 420 shown in FIG. 4. FIG. 4 is a diagrammatical illustration of web pages selected for data extraction by a user of the computer system of FIG. 1. The system 400 of FIG. 4 includes websites, page and data hints, and page and data clusters. The low level structure may be ascertained by using heterogeneous experts 430 to analyze the web pages 420 and the corresponding links with respect to a particular type of structure. As appreciated in the relevant art, “software experts” may be employed as heuristic knowledge types to perform the data extraction.

In an exemplary embodiment, one or more of the software experts 430 may use URL patterns, list structures, templates, and page layouts that can provide clues about groups of pages having similar types of data, for performing data extraction and clustering. The software experts 430 find substructures and output page hints 440 and data hints 450 to indicate the similarities and dissimilarities between items (i.e., pages or text-segments). Each heterogeneous expert 430 may be configured to focus on a particular type of structure and work independently from other experts 430 to examine URL patterns on the web-site 410.

A “URL” software expert 430, for example, may be helpful for identifying the web pages 420 that should go into a page cluster 460 and may thereby generate page-hints for pairs of pages whose URLs are similar. The URL software expert 430 typically computes the similarity of the URLs of two web pages 420 based on the length of the longest common subsequence of characters. It is appreciated in the relevant art that web pages 420 that contain the same type of data are usually generated by filling an HTML template with data values.

A “list structure” software expert 430 may operate by searching repeating patterns of a document object module (DOM) structure within each web page 420, particularly when the DOM structure is well-formed and reflects the structure of the underlying data. For web pages 420 in which special characters are used to format lists, rather than using HTML formatting tags, the list structure software expert 430 may not function as well as another software expert.

A “template” software expert 430 may be used to search for, or otherwise identify, token sequences that are common across pages. Token hints may be generated for such sequences whereby token sequences on the HTML web pages 420 can be arranged into a table cluster 470, so that eventually each table cluster 470 contains the data in a column of one of the underlying tables. The template expert 430 is more effective for identifying simple template structure shared by multiple web pages 420, and less effective for execution with a web site 410 that contain one or more web pages 420 not generated by the same grammar as other web pages 420. The template expert 430 typically determines the similarity of two pages by comparing the longest common sequence of tokens to the length of the web pages 420 of interest. The longer the sequence, the more likely the web pages 420 are to be placed into the same cluster.

A “layout” software expert 430 may use the visual representation of a web page 420 which reflects the structure of the data of interest. DOM nodes may be found that are aligned in vertical columns in the display 135, and can generate token-hints for the token sequences represented by these nodes. The page layout expert 430 typically analyzes the visual appearance of vertical columns on the page. To accomplish this analysis, the page layout expert 430 may generate a histogram of the counts of HTML elements that are positioned at each x-coordinate on the display 135. The similarity of these generated histograms is a good indicator that the relevant web pages 420 are of the same page-type. However, it may be more difficult to ascertain the similarity of two web pages 420 when a first web page 420 contains a short list of items, and a second web page 420 contains a long list of items.

After the software experts 430 have analyzed the input web pages 420, the operation may sometimes result in conflicting hints. To avoid complicating the clustering process, a probabilistic approach may be employed that provides a flexible framework for combining multiple hints in a principled way. In particular, a generative probabilistic model may be employed that assigns probabilities to hints (both token hints and page hints) given a clustering. This in turn enables searches for clusterings that maximize the probability of observing the generated page hints 440 and data hints 450.

Referring again to the flow chart 300 of FIG. 3, at step 315, the tabulation application 150 generates one or more tables, based on the structure of the web pages 180 analyzed and clustered in step 310. The user may collaborate with the tabulation application 150, at step 320, by giving feedback by: selecting one of the clusters of interest, by selecting and providing a preferred URL, or by browsing and modifying the one or more generated tables. The tabulation application 150 responds by re-learning the extractor such that the extractor subsequently operates to regenerate the one or more tables in accordance with the preferences of the user, and the process moves to decision block 325.

Alternatively, the user may provide sample URLs, at step 330, so as to direct the process of capturing web pages 180. The tabulation application 150 may generate one or more tables, based on the structure of the web pages 180 downloaded in step 330.

If the modified table is acceptable to the user, at decision block 325, a table agent may be created, based on the modified table properties, and additional content may be harvested, at step 340. If the modified table is not acceptable to the user, at decision block 325, the tabulation application 150 may re-learn the extractor, at step 345, after the user provided collaborative feedback and guidance. The one or more tables are regenerated, at step 350, in accordance with the re-learned user preferences, and the user again determines whether the new tables are acceptable, at decision block 325.

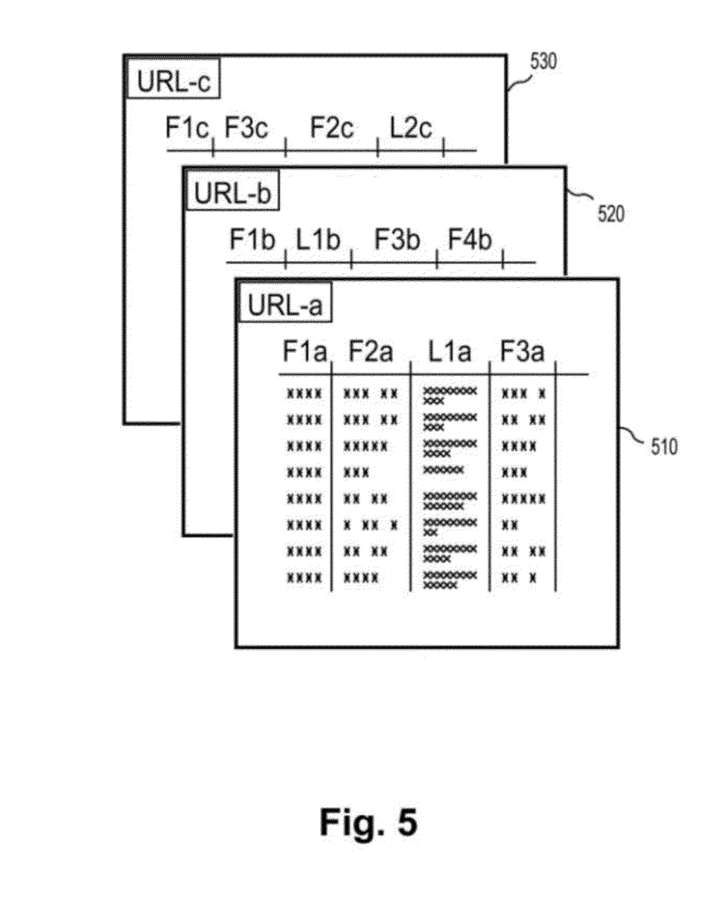

When the user has retrieved a plurality of web pages 180 of particular interest, the user may select two or more of the relevant web pages of greatest interest in FIG. 5. In the example illustrated, the user has selected three web pages 510, 520, and 530, having respective web addresses here denoted as “URL-a,” “URL-b,” and “URL-c.” As the three web pages 510, 520, and 530 were retrieved by any of the web page capture and data extraction processes described above, the web pages 510, 520, and 530 typically include similar types of data arranged in similar configurations.

As can be appreciated by one skilled in the relevant art, web pages typically include HTML coding for page formatting and presentation. The tabulation application 150 may function to use this HTML coding to identify fields, lists, and columns in the web pages 510, 520, and 530, or to create columns from the web pages 510, 520, and 530, for placement into a tabular format.

In an exemplary embodiment, the tabulation application 150 can propose a particular extractor, and may attempt to find landmarks and slots in the web page similar to what interests the user. A landmark may identify data fields and a slot may be a data field on a page. This procedure can begin with the acquisition of one web page, and then expand or contract the page columns as more web pages data types are identified. Or, a predetermined number of web pages can be clustered, and then the most common attributes can be appropriated for the suggested table, as explained in greater detail below.

In the diagrammatical example of FIG. 5, each of the three web pages 510, 520, and 530 includes three fields and one list, here shown as being displayed in a columnar format. All three web pages 510, 520, and 530 include similar fields of a first type (i.e., F1a, F1b, F1c) and similar fields of a third type (i.e., F3a, F3b, F3c). The two web pages 510 and 530 include similar fields of a second type (i.e., F2a, F2c) and the web page 520 includes a field of a fourth type (i.e., F4b). The two web pages 510 and 520 include similar listings of a first type (i.e., L1a, L1b) and the web page 530 includes a listing of a second type (i.e., L2c).

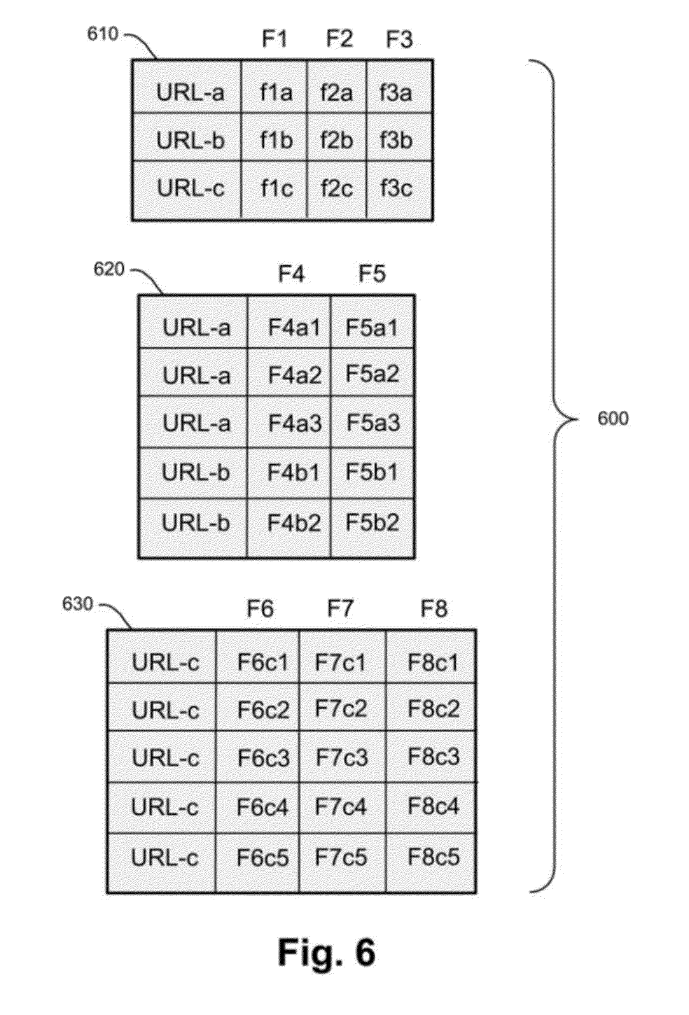

In response to the web page capture and selection, the tabulation application 150 automatically generates one or more initial, or proposed, structural tables, such as at steps 315 and 335 in FIG. 3. There is shown in FIG. 6, an example of an automatically generated table set 600 comprising a structural table 610 and two list tables 620 and 630. The column selections in the structural table 610 may be based on information obtained by analyzing HTML data extracted from the selected cluster. In the example provided, the tabulation application 150 has generated three field data table columns (i.e., F1, F2, F3) in the structural table 610, two field data table columns (i.e., F4, F5) in the list table 620, and three field data table columns (i.e., F6, F7, F8) in the list table 630. That is, the tabulation application 26 has taken field data and list data extracted from the web pages and selectively placed the extracted data into the columns of the respective tables.

In the example provided, the similar field data F1a, F1b, and F1c have been placed into the first field data column F1 by the tabulation application 150, the similar field data F2a, F4b, and F2chave been placed into the second field data column F2, the similar field data F3a, F3b, and F3c have been placed into the third field data column F3. Each of the list data L1a and L1b have been placed into respective list tables 620 and 630. Each of the list tables 620 and 630 comprises one or more fields. In the example provided, the list table 620 occurs on URL-a and URL-b, includes three rows of two fields, labled as column F4 and column F5. The list table 630 occurs on URL-c and includes three fields, labled as column F6, column F7, and column F8.

If the format of the table set 600 is acceptable to the user, at decision block 240 in FIG. 2 or decision block 325 in FIG. 3, the tabulation application 150 may continue to capture additional similar web pages and extract tabular data for placement into the table set 600, for example, with minimal input from the user. If the format of table set 600 is not acceptable to the user, the user may modify the table set 600 by one or more predefined actions, at step 260 in FIG. 2 and step 345 in FIG. 3, including but not limited to changing the characteristics and/or positions of the table columns by: adding headers to the table columns, deleting one or more columns, adding one or more fields or columns, merging two or more columns, filtering HTML data from column data, selecting different data items on a web page and substituting this data for the data in a table cell (i.e., changing the “markup”), and “pushing” columns left or right.

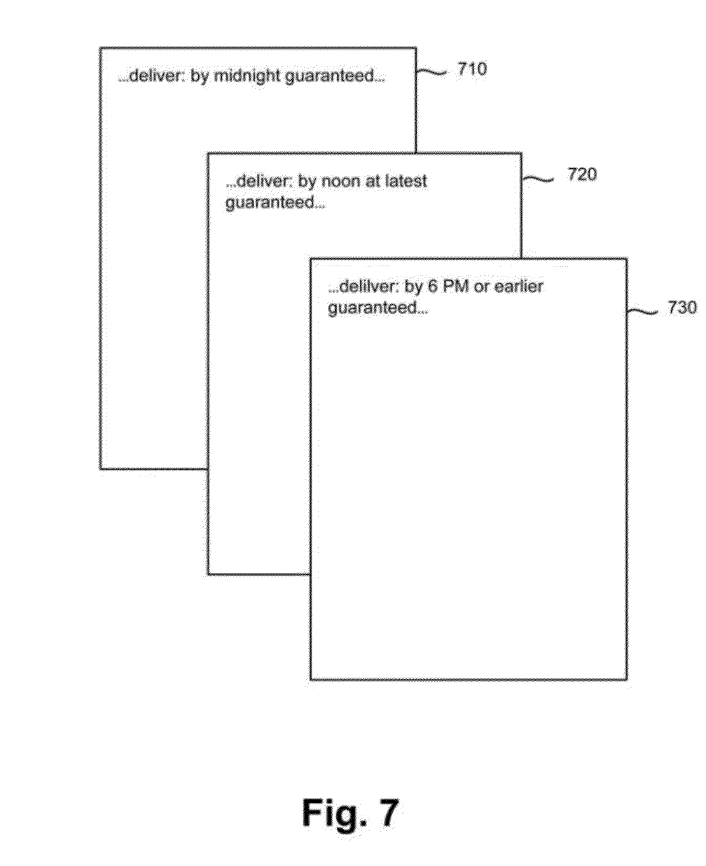

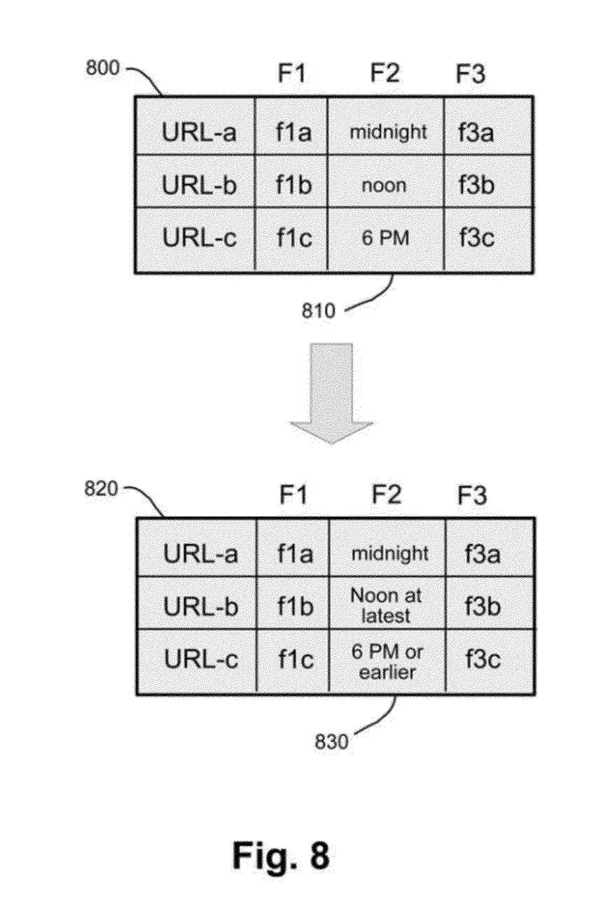

Operation of a “markup” command is illustrated in FIGS. 7 and 8. Portions of three web pages 710, 720, and 730 are shown in FIG. 7, where the phrase “ . . . deliver: by midnight guaranteed . . . ” appears in the web page 710, the phrase “ . . . deliver: by noon at latest guaranteed . . . ” appears in the web page 720, and the phrase “ . . . deliver: by 6 PM or earlier guaranteed . . . ” appears in the web page 730. The tabulation application 150 has generated a table 800, shown in FIG. 8, where the table 800 includes the data items “midnight,” “noon,” and “6 PM” in a column 810 (labeled F2). After the table 800 has been analyzed, by one or more methods described above, a modified table 820 has been produced, where the data item “midnight” remains unchanged, the data item “noon” has been changed to “noon at latest” by the user, and the term “6 PM” has been changed to “6 PM or earlier” by the tabulation application 150.

The user can also specify whether “hidden” data should appear in the table set 600, or if the data should remain hidden. As used herein, the term “hidden” refers to data that may not be visible on the web page 180, but is present in the HTML of the web page 180. In an exemplary embodiment, the table set 600 may have the option of showing only visible data, visible date with links, or all data. The tabulation application 150 thus automatically “learns” the table format preferred by the user. The tabulation application 26 then continues to capture additional, similar web pages and extract tabular data for placement into the structural table 98 formatted in accordance with the “learned” user preferences.

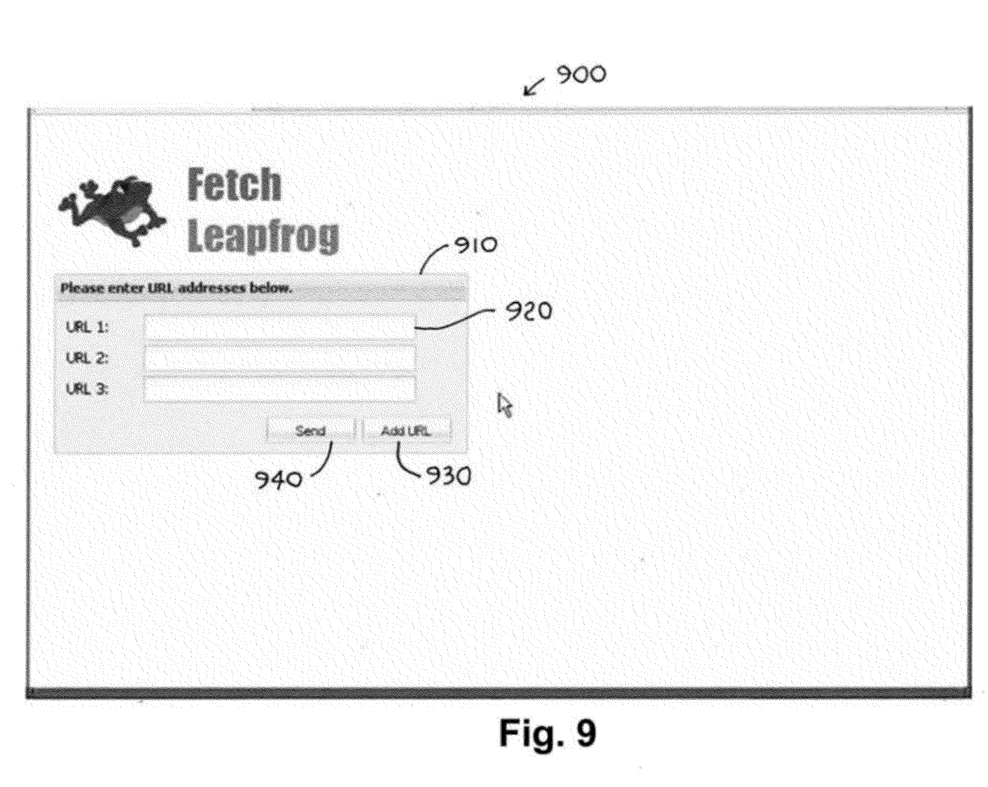

An exemplary embodiment of the process for generating modifiable data tables from web content pages in real time may be described with reference to the plurality of screen shots provided in FIGS. 9 through 14. FIG. 9 is a screen shot illustrating a structural table generated in response to the action performed in FIG. 8. An access screen 900 may be presented to a user on the display 135, as shown in FIG. 9. The access screen 900 includes a listing entry box 910 with a plurality of entry fields 920, of which only three are shown for clarity of illustration. An “add” button 930 may be provided for populating the entry fields, and a “send” button 940 may be provided to submit the URL selections to the tabulation application 150.

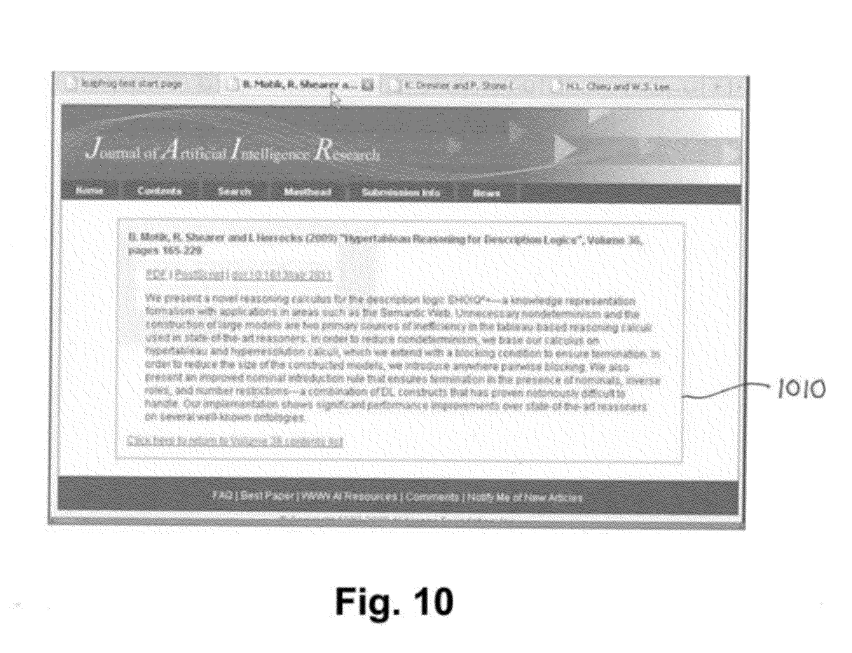

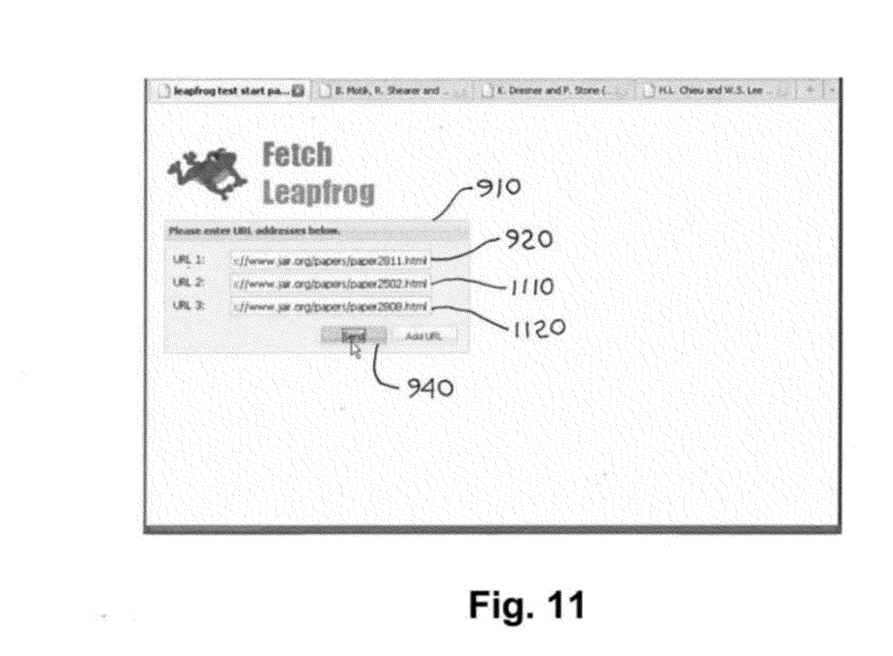

FIG. 10 is a screen shot showing that a user is viewing a selected web page 1010 containing a particular subject matter of interest, where the user then determines whether to continue finding additional, similar pages. The URL address for the initial web page 1010 may then be entered into a first entry field 920 in the listing entry box 910, as shown in FIG. 11. In the example provided, the user has also entered a second URL address in a second entry field 1110 and a third URL address in a third entry field 1120. The entry operations illustrated in FIG. 11 correspond to the user execution of step 330 in FIG. 3.

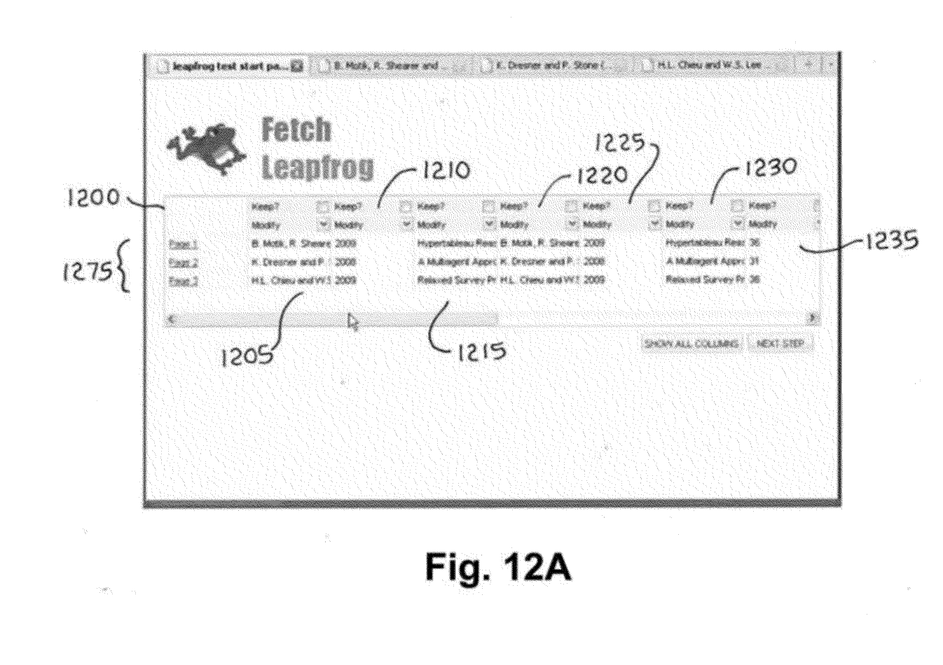

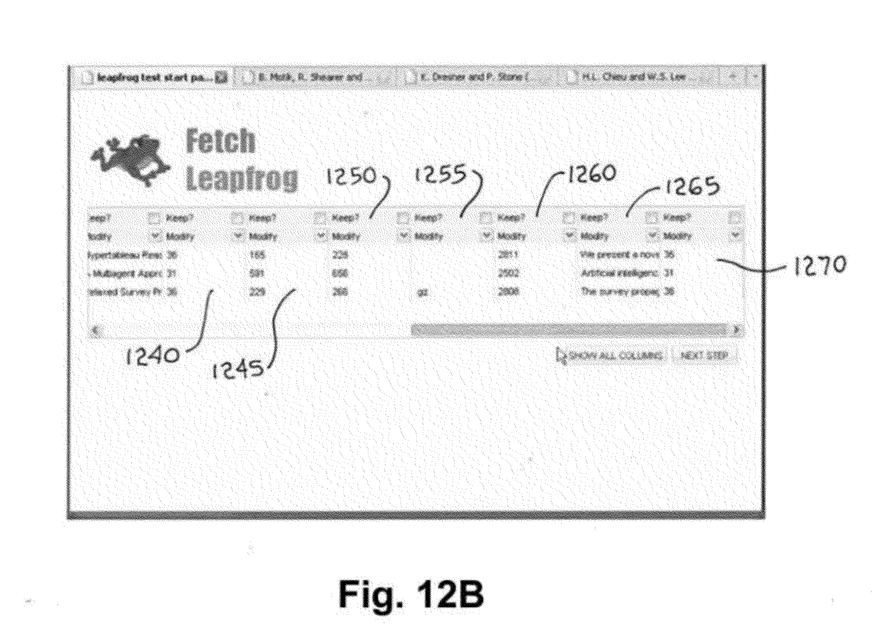

The user may “click” on the “send” button 940 to initiate a process by which the tabulation application 150 extracts relevant data identified by the HTML coding and begins populating a structural table 1200, as shown in FIGS. 12A and 12B. Each of the plurality of columns 1205-1270 in the structural table 1200 has a header that allows the user to check a box and indicate, for example, whether or not to “keep” the particular column and whether or not to “modify” the respective column. The structural table 1200 further includes a plurality of table rows 1275 displaying the relevant data extracted from the web pages corresponding to the user-selected URLs entered in the entry fields 920, 1110, and 1120, shown in FIG. 11. The operations illustrated in FIGS. 12A and 12B correspond to the user execution of step 335 in FIG. 3.

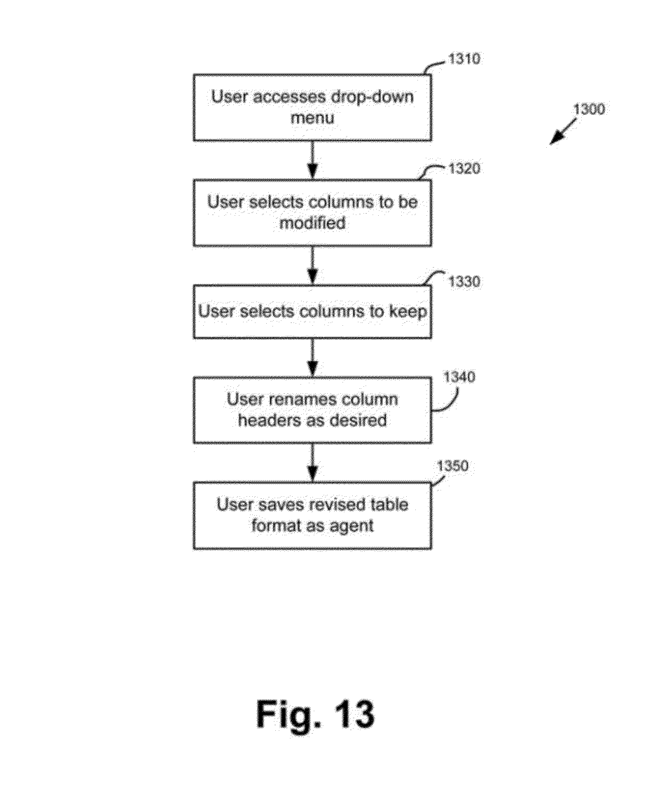

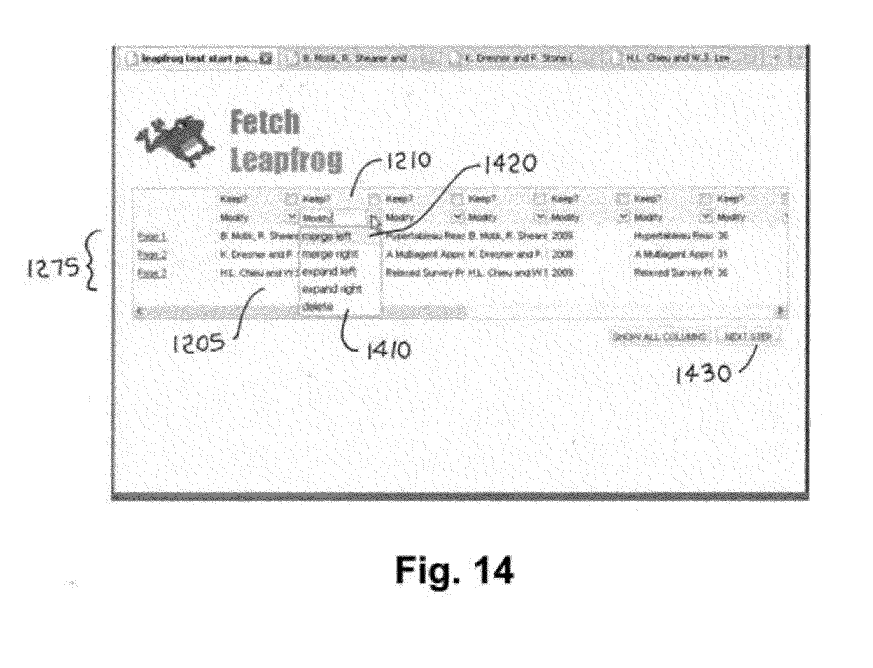

The exemplary embodiment of the process for generating data tables from web content pages in real time may be further described with reference to a flow chart 1300 provided in FIG. 13, and to the plurality of screen shots provided in FIGS. 14 through 19. The flow chart 1300 of FIG. 13 is a more detailed description of step 260 in FIG. 2 or step 345 in FIG. 3, that is, the process of modifying a structural table.

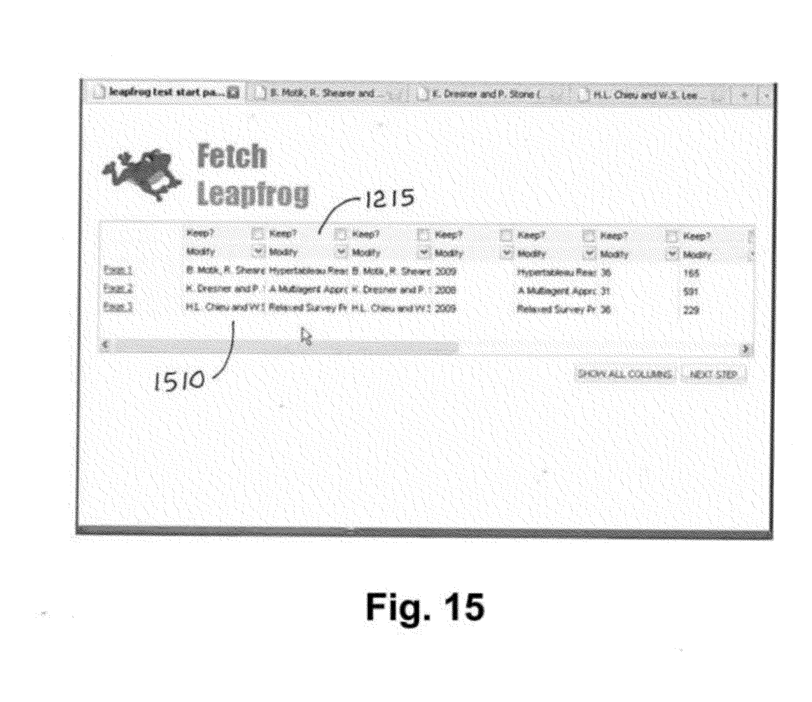

FIG. 14 shows a drop-down menu 1410 that may appear in any of columns 1205-1270 when the user has selected the respective “modify” box, at step 1310 in FIG. 13. In the example provided, the user has selected a “merge left” operation 1420 in the drop-down menu 1410, at step 1310, so as to combine the data in the column 1205 with the data in the column 1210 for each row in the table rows 1275 when a “next step” button 1430 is “pressed.” This operation produces a new column 1510 next to the column 1215, in place of the original columns 1205 and 1210, as shown in FIG. 15. The data in the column 152 includes the data originally present in the columns 122a and 122b. It should be understood that a “merge” operation combines the data in two selected columns, and everything between the two selected columns on the web page. Accordingly, if the data on the web page is “May 7, 2010” and a leftmost column includes the data “May 7”, and the rightmost column includes the data “2010”, then the resulting data in the “merged” column is “May 7, 2010”. That is, the comma is included in the merged column as it appeared as data between the leftmost data and the rightmost data.

Commands available to the user include, but are not limited to: a “Merge right/left” command that combines a slot (i.e., data field) to the right/left with a current slot; an “Expand right/left” command, that expands the current slot one token to the right/left; a “Delete” command that hides the current slot; a “Name” command that names the column; a “markup” command that allows the user to change the data contents of a table cell and then enable the tabulation application 26 to re-induce the extractor for the respective data column, and a “Filter HTML” command that removes HTML text from a slot.

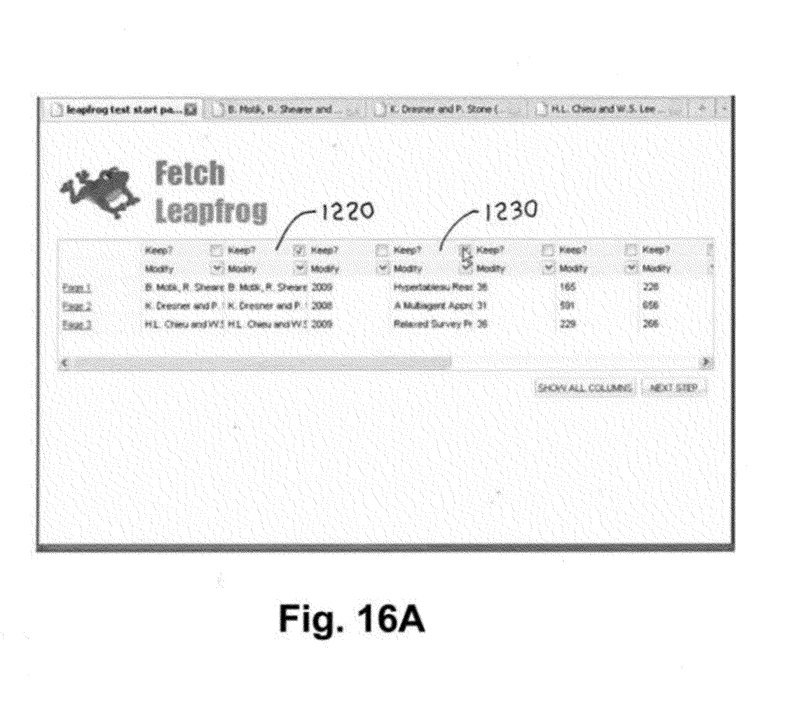

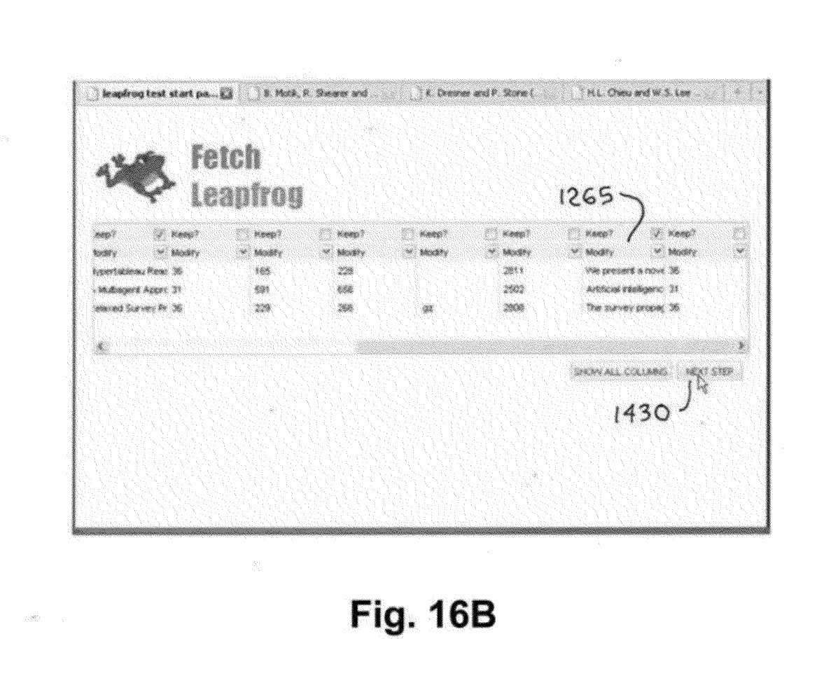

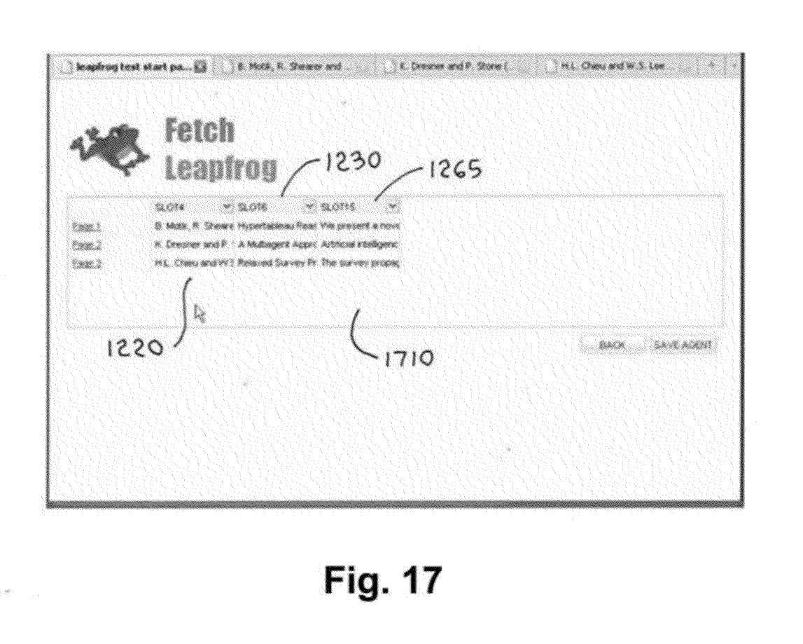

At step 1330 in FIG. 13, the user has made an election to “keep” columns 1220, 1230, and 1265, as shown in FIGS. 16A and 16B. The user “presses” the “next step” button 1430 to command the tabulation application 150 to generate a modified table 1710 comprising the column 1220 with a column heading designated as “slot 4,” the column 1230 with a column heading designated as “slot 6,” and the column 1265 with a column heading designated as “slot 15,” as shown in FIG. 17. It should be understood that, although the columns 1205-1215, the column 1225, the columns 1235-1260, and the column 1270 are “hidden” and do not appear in the modified table 1710, the hidden columns have not been “deleted,” and any or all of the hidden columns can be returned to a structural table upon a “restore” request initiated by the user. That is, in an exemplary embodiment these columns are not “expunged,” but rather, the deletion operation can be undone.

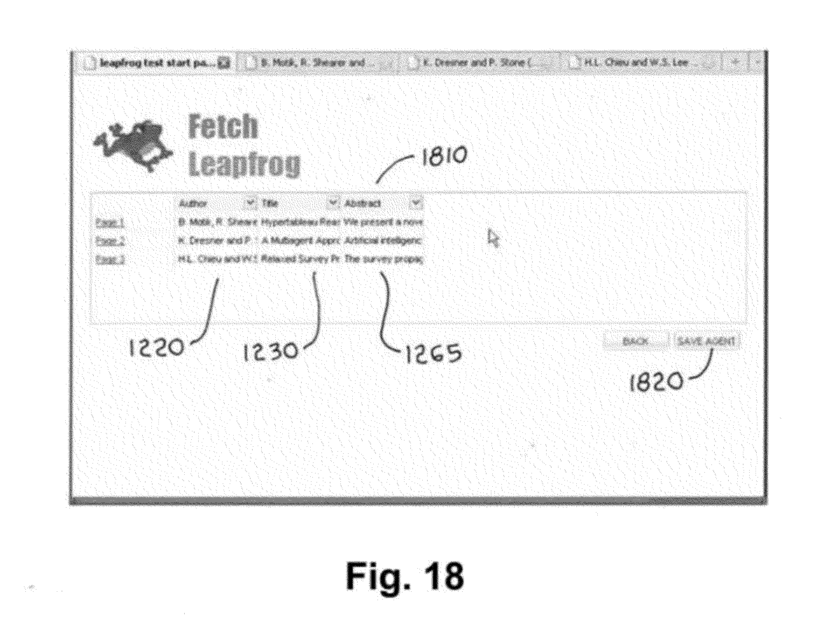

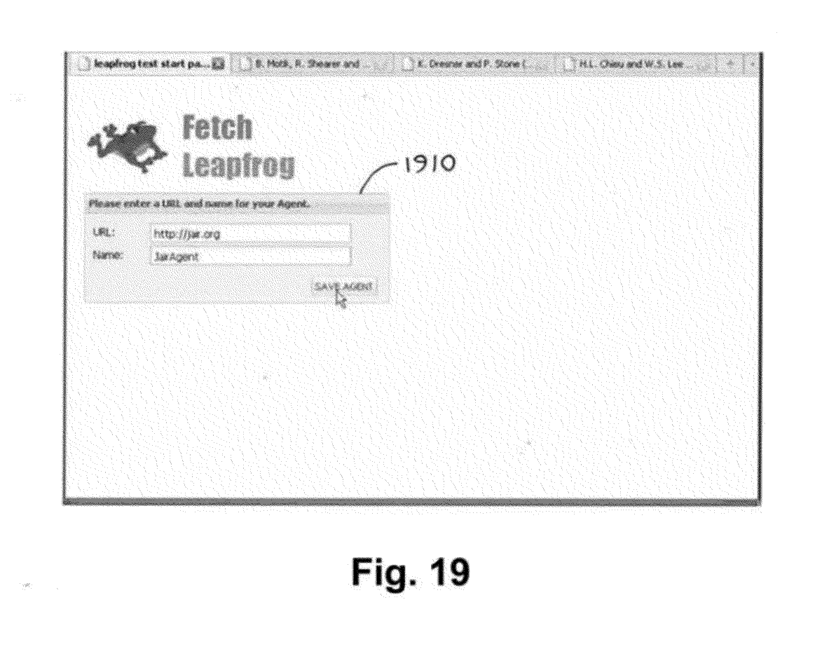

The user has next elected to modify the headings for the columns 1220, 1230, and 1265, at step 1340 in FIG. 13. FIG. 18 illustrates a final table 1810 having a new heading of “Author” for the column 1220, a new heading of “Title” for the column 1230, and a new heading of “Abstract” for the column 1265. The user may “press” a “save agent” button 1820, at step 1350 in FIG. 13, to save the format of the final table 1810 as an agent, with a URL, and agent name for the agent, as may be entered in a Save Agent window 1910, shown in FIG. 19.

In an exemplary alternative embodiment, the user can also format the data within a column to suit his preferences, and then save the format of the resulting table. The user may select a cell in the column intended for modification, cut and paste into the cell data in the display format selected by the user, and the corresponding display changes are made down the column by the tabulation application 150. The user may select a desired display format, make the change to a cell, and initiate the change in display to the rest of the cells in the column.

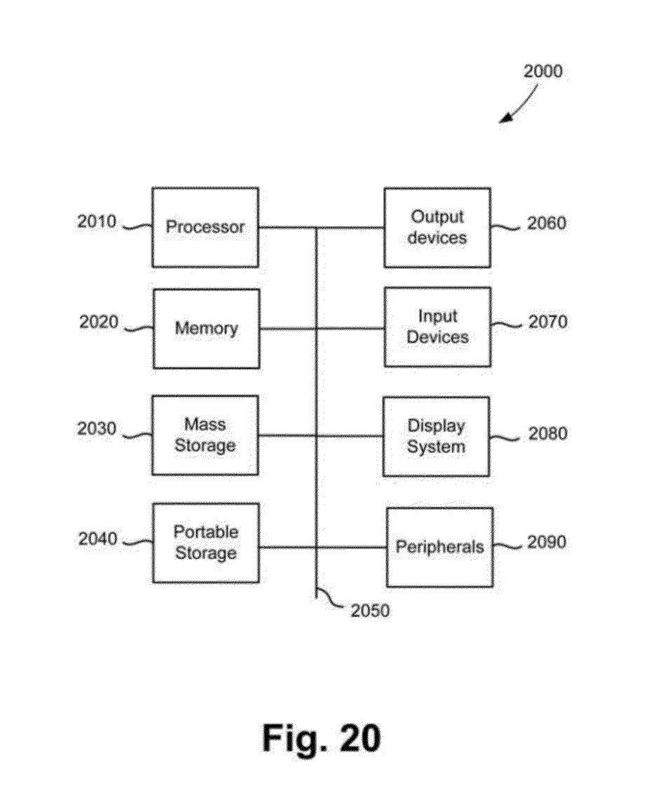

FIG. 20 illustrates an exemplary embodiment of a computing system 2000. Computing system 2000 may be used to implement system 100 of FIG. 1, portions of system 100, and may be used as an alternate to the computer system 100. The computing system 2000 of FIG. 20 may be implemented in the context of a mobile device, a computing device, or a network server, as understood in the present state of the art. The computing system 2000 comprises one or more processors 2010 and a main memory 2020. The main memory 2020 stores, in part, instructions and data for execution by the processor 2010. The main memory 2020 can further store the executable code for the tabulation application 150 when in operation. The computing system 2000 further comprises a mass storage device 2030, at least one portable storage medium drive 2040, at least one output device 2060, at least one user input device 2070, a graphics display 2080, and at least one peripheral device 2090.

The components shown in FIG. 20 may be interconnected via a single bus 2050. The components may be further connected through one or more data transport means. The processor unit 2010 and the main memory 2020 may be connected via a local microprocessor bus (not shown), and the mass storage device 2030, the peripheral(s) 2090, the portable storage device 2040, and the display system 2080 may be connected via one or more input/output (I/O) buses (not shown).

The mass storage device 2030, which may be implemented with a magnetic disk drive or an optical disk drive, is a non-volatile storage device for storing data and instructions for use by the processor unit 2010. The mass storage device 2030 can store the system software for implementing embodiments of the present invention, for purposes of loading the system software into the main memory 2020.

The portable storage device 2040 operates in conjunction with a portable non-volatile storage medium (not shown), such as a floppy disk, a compact disk (CD), or a digital versatile disc (DVD), to input and output data and code to and from the computer system 2000. The system software for implementing embodiments of the present invention may be stored on such a portable medium and input to the computer system 2000 via the portable storage device 2040.

The input devices 2070 provide a portion of a user interface, and may include an alpha-numeric keypad, such as a keyboard, for inputting alpha-numeric and other information, or a pointing device, such as a mouse, a trackball, stylus, or cursor direction keys. As noted above, the computer system 2000 may comprise one or more output devices 2060. Exemplary output devices include speakers, printers, network interfaces, and monitors.

The display system 2080 may include a liquid crystal display (LCD), a plasma display, or other suitable display device (not shown). The display system 2080 receives textual and graphical information from the system software, which processes the information for output to the display device.

The peripherals 2090 may include any type of computer support device to add additional functionality to the computer system 2000. The peripheral device(s) 2090 may include a modem or a router, for example.

The components contained in the computer system 2000 are those typically found in computer systems that may be suitable for use with embodiments of the present invention and are intended to represent a broad category of such computer components that are well known in the art. Thus, the computer system 2000 can comprise a personal computer, a hand held computing device, a cellular telephone, a personal data assistant (PDA), a mobile computing device, a workstation, a server, a minicomputer, a mainframe computer, or any other computing device. The computer system 2000 can also include different bus configurations, networked platforms, multi-processor platforms, etc. Various operating systems can be used including Unix, Linux, Windows, Macintosh OS, Palm OS, and other suitable operating systems.

The above description is illustrative and not restrictive. Many variations will become apparent to those of skill in the art upon review of this disclosure. The scope should, therefore, be determined not with reference to the above description, but instead should be determined with reference to the appended claims along with their full scope of equivalents.

What is claimed is:

1. A method for acquiring specified web-based data in a tabular format, the method comprising the steps of:
executing a module by a processor to perform a web searching operation to acquire web pages containing data; and
placing the predefined data into columns of a structural table to form a modifiable table, the characteristics and positions of the modifiable table columns being subsequently determined by a user.

2. The method of claim 1 wherein the step of performing a web searching operation comprises the step of providing at least one example URL to initiate the web searching operation.

3. The method of claim 1 wherein the step of placing the predefined data into columns of a modifiable table comprises the step of executing a tabulation application to automatically generate a structural table having columns for placement of web page data.

4. The method of claim 3 wherein the step of placing the predefined data into columns of a modifiable table is executed by the tabulation application.

5. The method of claim 3 wherein the step of executing a tabulation application resident in the computer to automatically generate a structural table comprises the step of analyzing HTML coding in the web page data to identify fields and lists to determine initial column format in the structural table.

6. The method of claim 5 further comprising the step of displaying hidden data in a column of the structural table.

7. The method of claim 1 wherein the step of placing the predefined data into columns of a modifiable table comprises the steps of:
analyzing the acquired web pages by using at least one software expert to determine similarity;
aggregating at least two web pages determined to contain similar data into a respective web page cluster; and
extracting data from a web page cluster and placing similar web page data into the same column of the modifiable table.

8. The method of claim 7 wherein column selections in the modifiable table may be based on information obtained by analyzing HTML data extracted from the web page cluster.

9. The method of claim 1 further comprising the step of merging two table columns into one table column.

10. The method of claim 1 further comprising the step of specifying a heading for at least one of the table columns.

11. The method of claim 1 further comprising the step of removing at least one column from the modifiable table.

12. The method of claim 1 further comprising the steps of:
selecting at least one cell in a column intended for modification;
cutting and pasting at least a portion of the data into the selected cell; and
changing the formatting of remaining cells in the column to conform to the format of the selected cell.

13. The method of claim 1 further comprising the step of using modified table characteristics to produce an agent for use in the placement of web data into the table columns.

14. A computer readable storage medium having embodied thereon a program, the program being executable by a processor to perform a method for acquiring specified web-based data in a tabular format, the method comprising:
performing a web searching operation to acquire web pages having predefined data; and
placing the predefined data into columns of a modifiable table, the characteristics and positions of the table columns being determined by a user.

15. The computer readable storage medium of claim 15, the method further comprising providing at least one example URL to initiate the web searching operation.

16. The computer readable storage medium of claim 15 wherein the method further comprises the step of modifying the modifiable table by at least one of: adding a header to a table column, deleting a table column, adding a table column, merging two table columns, filtering HTML data from column data, pushing a column left, and pushing a column right.

17. The computer readable storage medium of claim 15 wherein the method further comprises the step of analyzing HTML data extracted from the acquired web pages to determine the configuration of a column in the modifiable table.

18. A device suitable for acquiring specified web-based data and converting to a modifiable table, the device comprising:
means for acquiring web-based data;
a memory for storing a tabulation application that, when executed, functions to convert the acquired web-based data into a modifiable table; and
a display for displaying at least one of the web-based data and the modifiable table to a user.

19. The device of claim 18 wherein the means for acquiring comprises one of a wired network connection and a wireless network connection.

20. The device of claim 18 further comprising an input device whereby the user can implement modifications to a selected one of the web-based data and the modifiable table.
